(19) United States
(12) Patent Application Publication
(10) Pub. No.: US 2002/0129367 A1
(43) Pub. Date: Sep. 12, 2002

(54) Method and apparatus for personalized presentation of television/internet contents

(75) Inventor: Kavitha Vallari Devara, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/798,543

(22) Filed: Mar. 2, 2001

(51) Int. Cl. G06F 3/00; H04N 5/445; G06F 13/00; H04N 7/173

(52) U.S. Cl. 725/46; 725/47; 725/48

(57) ABSTRACT

A system and method for formatting broadcast/Internet contents according to the preferences of the user in terms of content, format, and presentation style, then presented in the time-slot specified by the user is disclosed. The system executes the following steps of: retrieving programs of interest to the user; storing the retrieved contents into a storage device; customizing stored contents according to predetermined criteria; and, displaying the customized contents corresponding to a time selected by a user. The user specifies the format of the whole program in terms of programs of interests, the length of the programs with respect to the whole program, and the presentation style of the whole program.

### BACKGROUND OF THE INVENTION

1. Field of Invention

The present invention relates to a system and method in which selected broadcast/Internet contents are presented according to the user's preferences in terms of content as well as user-defined format.

2. Description of the Invention

The modern world with huge amounts of multimedia content and varied delivery options gives us a tremendous variety and range of options and choices. Cable and satellite television delivers hundreds of different television channels each carrying a different program. Currently, over 500 different program channels are shown through a cable television service. At the same time, the on-line services also offer a variety of different services to consumers, including electronic news, private message services, games, and other related downloadable services. In addition, standards are being developed to synchronize content from various sources, e.g., web-content like HTML pages and the URL links with a live television program.

As more enriching information is available to consumers, a user may have to listen continuously and often to many different programs in order not to miss important or interesting information. Accordingly, viewers often spend a lot of time “channel surfing,” trying to find something he or she is interested in watching. Also, users have to browse the web content while watching television shows to find the latest information from their favorite web-sites. As a result, viewers typically have to sort a great amount of information from various sources that is not of interest in order to receive information which is of interest. Therefore, there is a need to customize and merge television programming and the information superhighway of the Internet so that the frustration associated with finding anything on the hundreds of different programs can be minimized.

### SUMMARY OF THE INVENTION

It is, therefore, an objective of the present invention to allow consumers to receive more information in a more efficient manner than either television or the Internet alone.

It is another objective of the present invention to provide a means so that the materials of interest are selectively delivered to the consumer automatically.

It is a further objective of the present invention to integrate audio/visual and textual contents from different sources so that consumers do not waste a lot of time searching for the contents they need.

### BRIEF DESCRIPTION OF THE DRAWINGS

The above and other objectives, features, and advantages of the present invention will become more apparent from the following detailed description when taken in conjunction with the accompanying drawings, in which:

FIG. 1 illustrates a simplified block diagram of the system according to the present invention;

FIG. 2 is a diagram showing the integration of the television and Internet contents according to the present invention;

FIG. 3 is a diagram showing the user interface screen according to the present invention; and,

FIG. 4 is a flow diagram of operation steps of the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments which depart from these specific details. Moreover, for the purpose of clarity, detailed descriptions of well-known devices, circuits, and methods are omitted so as not to obscure the description of the present invention with unnecessary detail.

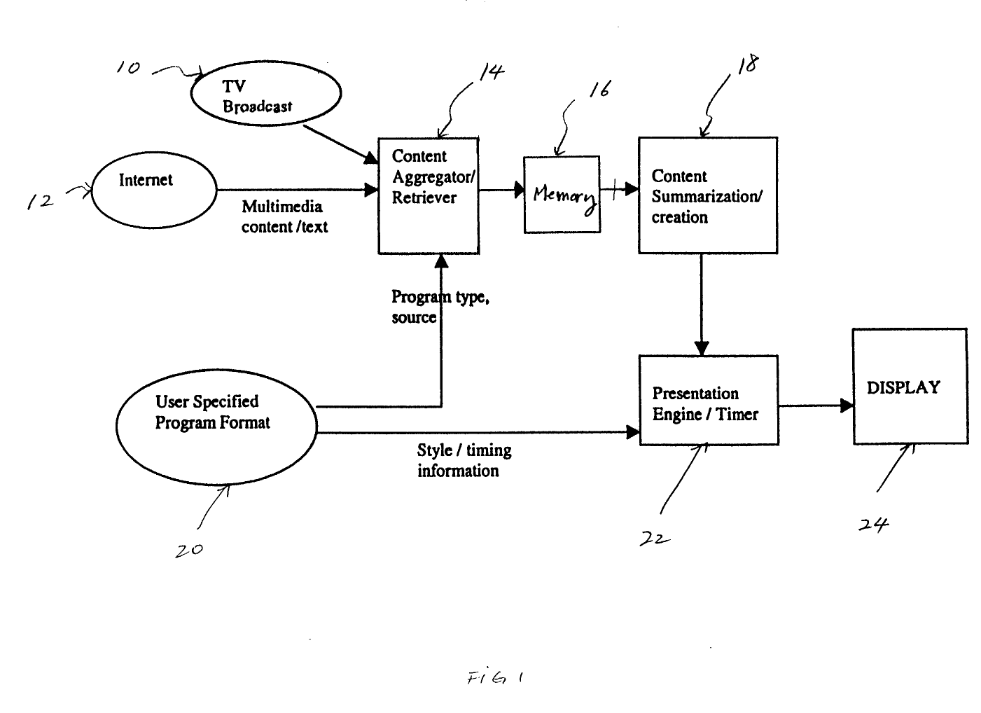

Referring to FIG. 1, a preferred embodiment of the present invention is a system for customizing content (audio, video, and data) from television and other content sources (e.g., Internet) according to their objective preferences. The system is configured to receive audio/video programming and data signals from the conventional television (TV) broadcast 10 and the Internet 12, respectively. According to the embodiment of the present invention, the audio/video programming along with the data signals can be delivered in analog, digital or digitally compressed formats via any transmission means, including satellite, cable, wire, television broadcast or sent via the Web. The Internet connection can be via a high-speed line, RF, conventional modem or by way of a two-way cable carrying the video programming. It should be noted that the present system is capable of being connected to other possible networks, such as a direct private network and a wireless network.

In the embodiment of the present invention, the audio/video that is broadcast over a conventional broadcast or cable transmission means as well the related Web pages retrieved via the Internet system are aggregated according to the objective preferences of the consumer. Then, the aggregated information is presented in a predetermined format for viewing in the time-slot specified by the consumer. To this end, the content aggregator/retriever 14 is provided to receive the TV broadcast and Internet contents. The retrieved broadcast and Web contents are briefly stored in the memory 16, then forwarded to the content summarization/creation module 18. The content module 18 formats the retrieved contents according to a user specified program format 20 (explained hereinafter). Thereafter, the presentation engine/timer module 22 presents the formatted content to the display unit 24 for viewing.

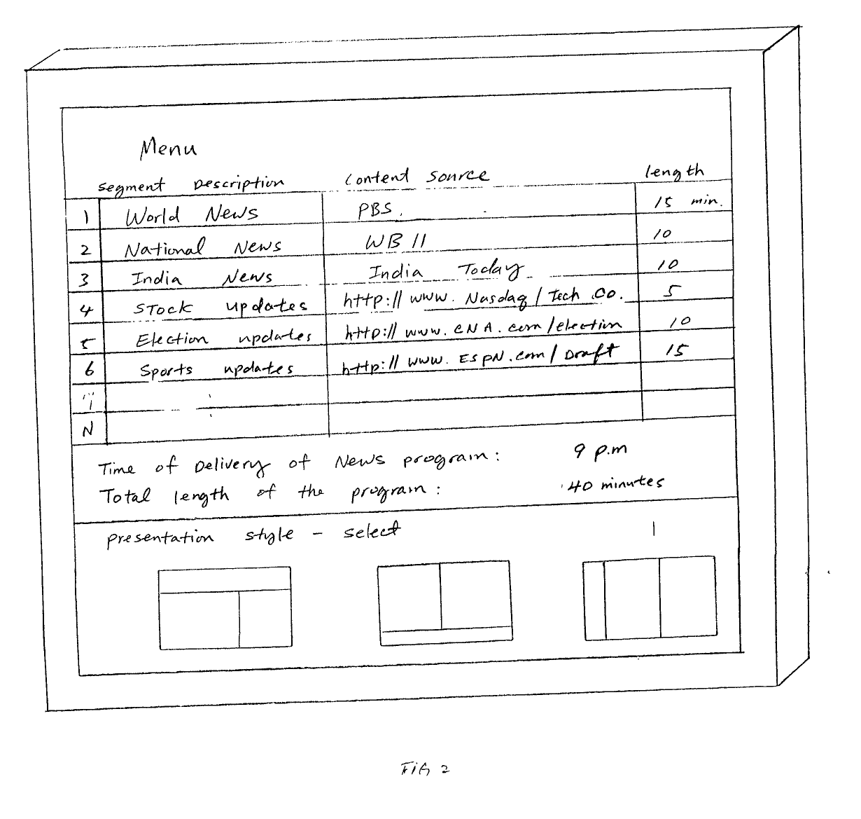

Referring to FIG. 2, the user may designate the type of the content as well as the sources of content that is preferred by him/her. Using an interface screen as shown in FIG. 2, the user is able to customize the viewing of these designated contents as they wish. That is, a user may select to receive a variety of data and/or TV broadcast programming from different sources that is customized to their preferences. To select the desired TV programs, a well-known electronic program guide (EPG) protocol is utilized. An EPG is a standard application designed to aid the viewer in the navigation of and selection from broadcast material available in a digital TV environment. Basically, an EPG is an interactive, on-screen display feature that displays information analogous to television listings found in local newspapers or TV guides or EPG services like tribune. The EPG provides information about each program and includes programming characteristics, such as the channel number, program title, start time, end time, elapsed time, time remaining, rating (if available), topic, theme, and a brief description of the program's content. Using the EPG features, viewers can select any channel any time during some period.

By utilizing the EPG information, the viewers can specify the type of program they desire to watch in the present invention. For example, the user may wish to choose multiple TV news programs as well as update news from some Internet web sites. In particular, the viewers may decide to accumulate specialized news channels from various news sources, then format the accumulated contents into a specific format to be viewed by the users. A specialized news channel may broadcast only stories relating to sports or finance, or the like. In addition, specialized news contents are repeated more often than the general interest (i.e., Daily 9 o'clock news), or not repeated at all. Accordingly, viewers can generate a content listing, which includes more than one specific news category, from different sources.

Furthermore, according to the present invention, the user may specify the format of the whole program at a specified time-slot, in terms of (1) segments of interest (i.e., the type and source of the content); (2) lengths of segments with respect to the whole program; and, (3) presentation style of the program. A sample format specified above is illustrated in FIG. 2. Segment 1 corresponds to the “World news” from the PBS station for the duration of 15 minutes. Segment 2 corresponds to “National news” from the WB 11 station for the duration of 10 minutes. Segment 3 corresponds to “India News” from the India-today station for the duration of 10 minutes. Segment 4 corresponds to the Stock quote newsletter downloaded from the Nasdaq Web page for the duration of 5 minutes. Segment 5 corresponds to the Election updates newsletter downloaded from the CNA News Web page for the duration of 10 minutes. Segment 6 corresponds to the Sports updates downloaded from the ESPN Web page for the duration of 15 minutes. Accordingly, multiple segments of different programs can be arranged to be viewed simultaneously or in sequence via one display screen. Here, the time of delivery for the above news program and updates is set to 9:00 p.m., and the total length of the whole program is set to, for example, 40 minutes. After selecting the desired program at a specified time, the present invention also allows the user to customize the display format for the whole programming as specified by the user. For example, as shown in FIG. 2, the users may be provided with an option to select one of the pre-formats designated by the system, or may decide to customize the arrangement of the content as they wish.

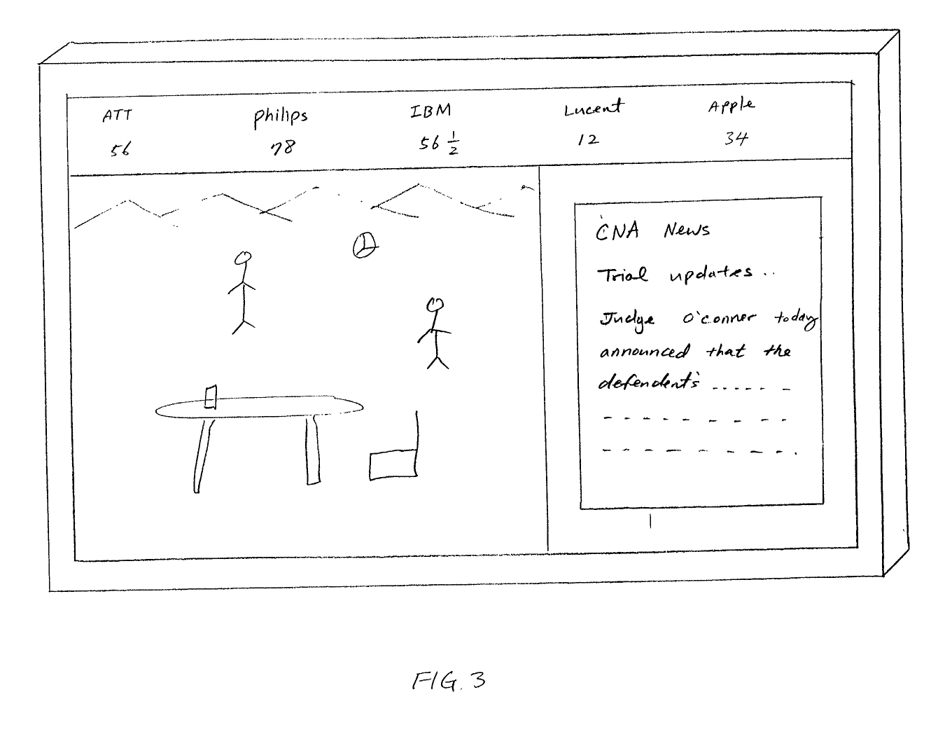

FIG. 3 depicts the format of the selected segments, as described in the preceding paragraphs, in which the segment 4 relating to stock quotes from IBM, Philips, or other High-tech companies is displayed on the upper portion of the screen. In a preferred embodiment, a JAVA-enabled browser is installed in the content aggregator/retriever 14 to allow the system to retrieve the Web pages. The content retriever 14 directs the JAVA-enabled browser to retrieve the particular relevant Web pages via the Internet. These Web pages will then be formatted via the content creation module 18 and displayed on the display screen 24 via the presentation engine/timer 22 at particular times. Therefore, while the viewer is watching a picnic scene from a particular TV channel, information on the stock quotes can also be displayed adjacently on the top window. At the same time, another section of the screen can include election update news in data form that is downloaded from another Web page. Accordingly, data and video programs can be simultaneously viewed on the same screen as specified by the user.

It should be understood that although information relating to a news program is illustrated as an example, any other program can be arranged in various formats. Also, the user preference can be updated and rearranged on a continuous basis to reflect each viewer's changing preferences. Furthermore, if video segments are not available for a particular segment, text information may be presented along with audio segments, if available.

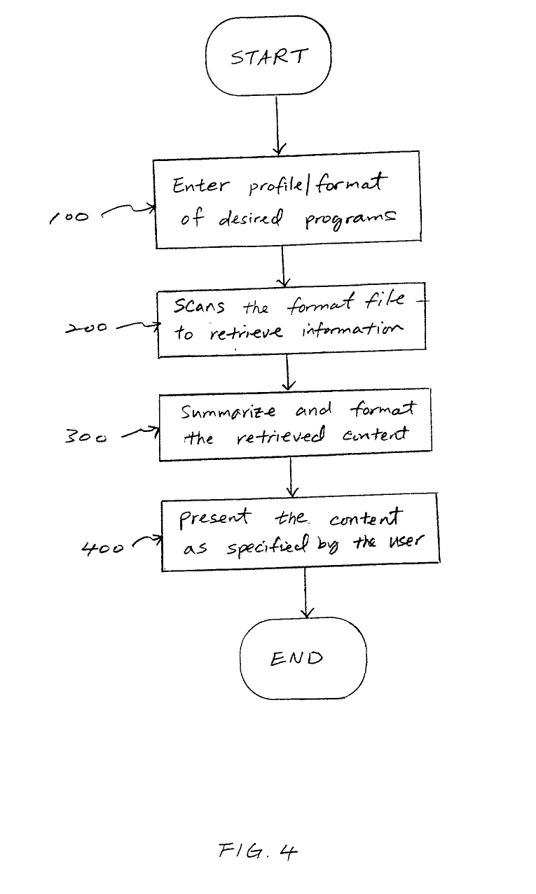

Referring to FIG. 4, the system as depicted in FIG. 1 can be implemented as follows. First, in step 100, the user enters the type of the content as well as the source of content in the format file 20 as shown in FIG. 2, or any other program similar to the news program that has a specific format and content. At each viewer cite, the content retriever 14 receives the cable transmission by cable connection on the back of the system and receives the Internet content directly through an Internet connection. In step 200, the content receiver 14 scans the format file 20 and searches the EPG information to find out when the specified programs of interest to the user are being broadcast (before the time scheduled set by the user as “News Program time: 9 p.m.”), then schedules a recording of that particular program. Simultaneously, the content receiver 14 will search the Internet for the information-sources listed by the user. If the information is available, the content receiver 14 retrieves the specified news stories or updates the information of interest. Then, the retrieved contents are briefly stored in the memory 16.

In step 300, the content creation module 18 will customize the retrieved content within the time limitation specified by the user. At the same time, the content creation module 18 formats the retrieved content according to the preferred format specified by the user. The content creation is accomplished according to any conventional means known in the art so that the viewers may receive data or audio/video content customized to their objective preferences. Alternatively, some information could be presented as text overlay, instead of an elaborate video, if the video is too long. Also, some text information can be presented in audio sound.

Finally, in step 400, the newly formatted content can be processed for display via the presentation engine/timer module 22 according to the format and time of display that are specified by the user. Here, the video/audio program can then be processed for display on the TV screen using any conventional interface card capable of displaying signals on the TV monitor. Web contents may be synchronized to the video content for display on different portions of the display screen.

As a result, a viewer can begin watching, at the designated time, all the programs including the web content of interest, thereby providing more engaging and efficiently informative experience to the viewer. Accordingly, viewers do not have to search through the millions of pages on the Internet or continuously watch lengthy programs to find the appropriate material.

Having thus described a preferred embodiment of the invention for selectively retrieving and formatting the TV and Internet content, it should be apparent to those skilled in the art that certain advantages of the system have been achieved. The foregoing is to be constructed as only being an illustrative embodiment of this invention. Persons skilled in the art can easily conceive of alternative arrangements providing a functionality similar to this embodiment without any deviation from the fundamental principles or the scope of this invention.

What is claimed is:

1. A method for customizing information from a plurality of sources, said method comprising the steps of:
retrieving at least one television content and at least one Internet content;
storing said retrieved contents into a storage device;
formatting said stored contents according to predetermined criteria; and,
displaying said formatted contents corresponding to a time selected by a user.

2. The method of claim 1, further comprising the steps of generating a content list including said at least one television channel and said at least one Internet address, said content list selectable by a user.

3. The method of claim 2, wherein said content listing includes information selected from the group consisting of: program description, source, length, starting time, ending time, and combination thereof.

4. The method of claim 1, further comprising the step of displaying text information corresponding said television content if said television content is unavailable.

5. The method of claim 1, wherein said television content is selectively retrieved according to an electronic program guide (EPG).

6. The method of claim 1, wherein said predetermined criteria defines the length, source, and duration of said at least one television content and said at least one Internet content.

7. The method of claim 1, said plurality of sources includes at least one of television network, Internet network, wireless network, and wired network, or combination thereof.

8. A method for customizing information, said method comprising the steps of:
generating a content listing including at least one television content and at least one Internet content, said content listing being selectable by a user;
retrieving the corresponding information provided in said content listing into a storage device;
merging said at least one television content with said at least one Internet content; and,
displaying said merged contents on a display device according to predetermined criteria;

9. The method of claim 8, wherein said step of merging is performed interactively in response to user input.

10. The method of claim 8, wherein said content listing includes information selected from the group consisting of program description, source, length, starting time, ending time, and combination thereof.

11. The method of claim 8, further comprising the step of displaying text information corresponding to said television content if said television content is unavailable.

12. The method of claim 8, wherein said television content is selectively retrieved according to an electronic program guide (EPG).

13. The method of claim 8, said retrieved information downloaded from at least one of television network, Internet network, wireless network, and wired network, or combination thereof.

14. The method of claim 8, wherein said predetermined criteria defines the length, source, and duration of said at least one television content and said at least one Internet content.

15. A system for customizing information from a plurality of sources, comprising:
means for retrieving at least one television content and at least one Internet content according to predetermined criteria;
means for storing said retrieved contents;
means for formatting said stored contents according to a prescribed format; and,
means for displaying said formatted contents corresponding to a time selected by a user.

16. The system of claim 15, further comprising an input device adapted to communicate with said system to enter a content listing including said at least one television content and said at least one Internet content.

17. The system of claim 15, wherein said retrieving means comprises a web browser for receiving said at least one Internet content.

18. The system of claim 15, wherein said television content is selectively retrieved according to an electronic program guide (EPG).

19. The system of claim 15, wherein said predetermined criteria defines the length, source, and duration of said at least one television content and said at least one Internet content.

20. The system of claim 15, further comprising the step of displaying text information corresponding to said television content if said television content is unavailable.
